(19) United States
(12) Patent Application Publication
(10) Pub. No.: US 2010/0112857 A1
(43) Pub. Date: May 6, 2010

(54) CONDUCTING DEVICE FOR THE ELECTRIC CONTACT OF A CONDUCTING SHIELDING SHEATH

(75) Inventors: Fabrice Bianchi, Jonage (FR); Arsene Schmidt, St Cyr au Mont d'Or (FR)

Correspondence Address: CANTOR COLBURN, LLP, 20 Church Street, 22nd Floor, Hartford, CT, 06103, US

(73) Assignee: ABB FRANCE, RUEIL-MALMAISON (FR)

(21) Appl. No.: 12/529,563

(22) PCT Filed: Feb. 8, 2008
(86) PCT No.: PCT/FR2008/000156

§ 371 Date: Sep. 23, 2009

(30) Foreign Application Priority Data
Mar. 9, 2007 (FR) 0701733

(51) Int. Cl. H01R 9/05

(52) U.S. Cl. 439/585

(57) ABSTRACT

The invention relates to a conducting device (11) for establishing an electric contact between a first shielding sheath (12) of a first armoured conductor and the second shielding sheath (12) of a second armoured conductor or a shielding reference member, wherein said device is intended to be mounted on an electric connection apparatus (2) that comprises at least one connection terminal for the conductors, and a conducting member (13) extending between a first end to be provided in the vicinity of a first connection terminal of the apparatus (2) and a second end to be provided in the vicinity of a second connection terminal of the apparatus (2), or in contact with the reference shielding member. The device further includes at least one housing member (14) for a conductor (3) with its sheath, said member being in electric contact with one of the ends of the conducting member (13), and means (19) for maintaining the housing member in position and in contact with the shielding sheath (12) of a conductor (3).

### TECHNICAL FIELD OF THE INVENTION

The present invention relates to a conducting device for electrical contact between a first shielding sheath of a first shielded conductor and a second shielding sheath of a second shielded conductor or a reference element for shielding, and an apparatus for connecting conductors.

### BRIEF SUMMARY OF RELATED ART

It is known practice in certain low-voltage applications to protect the conductors designed to carry signals, for example control signals, via electromagnetic shielding.

The function of such shielding is to protect the signal which is transmitted by the conductor from the electromagnetic interference present in the environment, and so that the conductor does not emit such interference, by producing electromagnetic insulation.

The shielding of the conductor is carried out in a known manner by placing around each conductor a sheath made of a conductive material, in the form of braid for example, creating a Faraday cage effect around the conductor.

When two conductors of the abovementioned type are connected in a connection apparatus, for example in a terminal block, it is important that shielding continuity is ensured at least partially between the first and the second conductor.

Accordingly, it is known practice to provide an electric contact between the sheath of the first conductor and the sheath of the second conductor.

Such a contact is achieved in a known manner by a conducting element in the form of a conductive bar, which extends between a first end close to a first connection terminal and a second end close to a second connection terminal of the connection apparatus, the sheath of the first conductor being attached to the first end of the bar, and the sheath of the second conductor being attached to the second end of the conductive bar.

The sheaths may be attached to the bars by twisting the end of the sheath in order to form a strand, then attaching it to the bar via a cable terminal crimped onto the strand or by soldering.

It is also possible to achieve the attachment by soldering without first twisting the end of the sheath.

The attachment methods specified above make it possible to obtain an electric contact between the first and the second sheath. However, soldering and/or twisting the sheath damage the quality of continuity of the shielding produced.

Consequently, it is desirable to achieve an attachment of the sheaths which makes it possible to ensure better shielding continuity, while not making this attachment complex.

It is known from document DE20004475U how to produce a conducting device for electrical contact between a first shielding sheath of a first shielded conductor and a second shielding sheath of a second shielded conductor or a reference element for shielding, the device being designed to be fitted to an electrical connection apparatus comprising at least one conductor connection terminal, and comprising:
a conducting element extending between a first end designed to be placed close to a first connection terminal of the apparatus and a second end designed to be placed close to a second connection terminal of the apparatus, or in contact with the reference element for shielding,
at least one housing member of a conductor surrounded by its sheath, this member being in electrical contact with one of the ends of the conducting element, and
means for holding the housing member in position in contact with the shielding sheath of a conductor.

### BRIEF SUMMARY OF THE INVENTION

The invention allows an enhancement of the shielding while allowing the use of known attachment methods.

Accordingly, the present invention relates to a device of the abovementioned type, characterized in that it also comprises a connection lug comprising at least one opening particularly allowing the passage of a strand formed by the end of a twisted shielding sheath of a shielded conductor or the housing of a protruding portion for the attachment of a fitted external cable terminal.

Therefore, it is possible to achieve contact between the device and the sheath of each conductor without having to produce a twisted strand with the sheath, and by directly achieving contact on the conductor. These arrangements also make it possible to prevent soldering which is unfavorable to the good continuity of the shield.

It is also possible to use the known attachment methods with the device according to the invention. In particular, a twisted strand which is housed in the at least one through-opening may be soldered to the device. It is also possible to use a cable terminal fitted to the end of a twisted strand of the wire sheath, such a cable terminal usually comprising a protruding portion designed for its attachment.

Advantageously, the housing member has a concave shape for housing the conductor.

These arrangements make it easier to position the conductor in the housing member.

According to one embodiment, the housing member comprises a bottom and two lateral branches extending obliquely relative to the bottom.

These arrangements make it possible to house conductors of different sizes with one and the same housing member.

According to one embodiment, the connection lug is made in a recess of the housing member.

This arrangement makes it possible to simply produce the housing member and the connection lug in a single piece, and to limit the space requirement associated with the presence of this connection lug.

Advantageously, the connection lug is pliable relative to the housing member.

This arrangement makes it possible to separate the connection lug from the plane of the bar and from alignment with the housing member in order to make the manipulations easier for the operator wishing to use this connection lug.

According to one possibility, the means for holding the housing member in position on the conductor comprise at least one portion of the housing member that is designed to be crimped around the conductor.

This arrangement means that it is not necessary to use a fitted piece in order to achieve attachment to the conductor.

Advantageously, the at least one portion designed to be crimped around the conductor consists of at least one end portion of a branch of the housing member.

According to another possibility, the means for holding the housing member in position on the conductor comprise a fitted clamping collar.

This arrangement means that it is not necessary to use a crimping tool, but the holding in position can be achieved simply in a manual manner.

Advantageously, the clamping collar comprises a conductive sheath.

This arrangement makes it possible to promote electrical contact between the device and the shielding sheath of the conductor.

According to one embodiment, the guidance housing member comprises at least one positioning notch for the clamping collar.

This arrangement makes it easier to position the clamping collar on the positioning member, and hold it in position, preventing movements of the collar transversely to the direction of clamping.

Advantageously, the branches of the guidance housing member comprise a profile having a positioning notch for the clamping collar.

According to one embodiment, the device comprises means for attachment to the insulating body of the apparatus.

This arrangement makes it possible to achieve an easy, toolless attachment of the device to a connection apparatus comprising appropriate openings.

Advantageously, the attachment means consist of snap-fitting elements.

Advantageously, the conducting element, consisting of a bar, and the at least one housing member are made in a single piece.

This arrangement makes manufacture easier and also makes it easier to achieve a good quality electric contact.

The present invention also relates to a low-voltage connection apparatus comprising a device as described above.

In any event, the invention will be well understood with the aid of the following description, with reference to the appended schematic drawing, representing, as a nonlimiting example, two embodiments of a device according to the invention.

### BRIEF DESCRIPTION OF THE DRAWINGS

FIG. 1 is a view in perspective of a device according to a first embodiment of the invention.

FIG. 2 is a second view in perspective of the device of FIG. 1, in a different orientation.

FIG. 3 is a view in perspective of a conductor connection apparatus according to the invention.

FIG. 4 is a schematic view representing the components of a shielded conductor.

FIG. 5 is a view in perspective of the means of attaching a device according to the invention.

FIG. 6 is a view in perspective of a conductor attached to a housing member of the device of FIG. 1.

FIG. 7 is a view in section of a device according to a second embodiment of the invention.

FIG. 8 is a view in perspective of a variant of the device of FIG. 1.

### DETAILED DESCRIPTION OF THE INVENTION

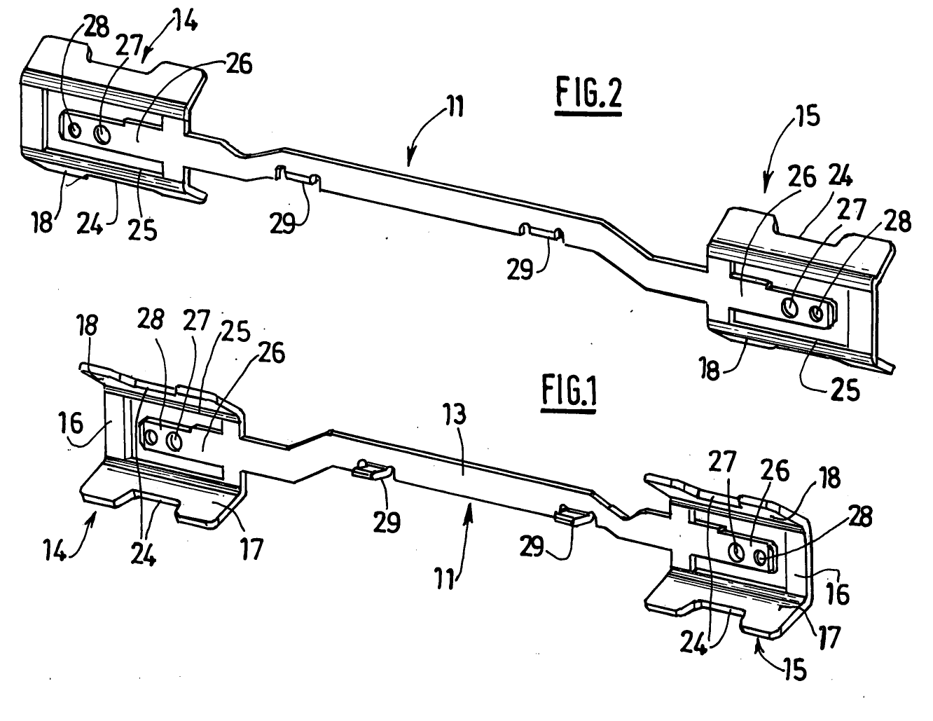

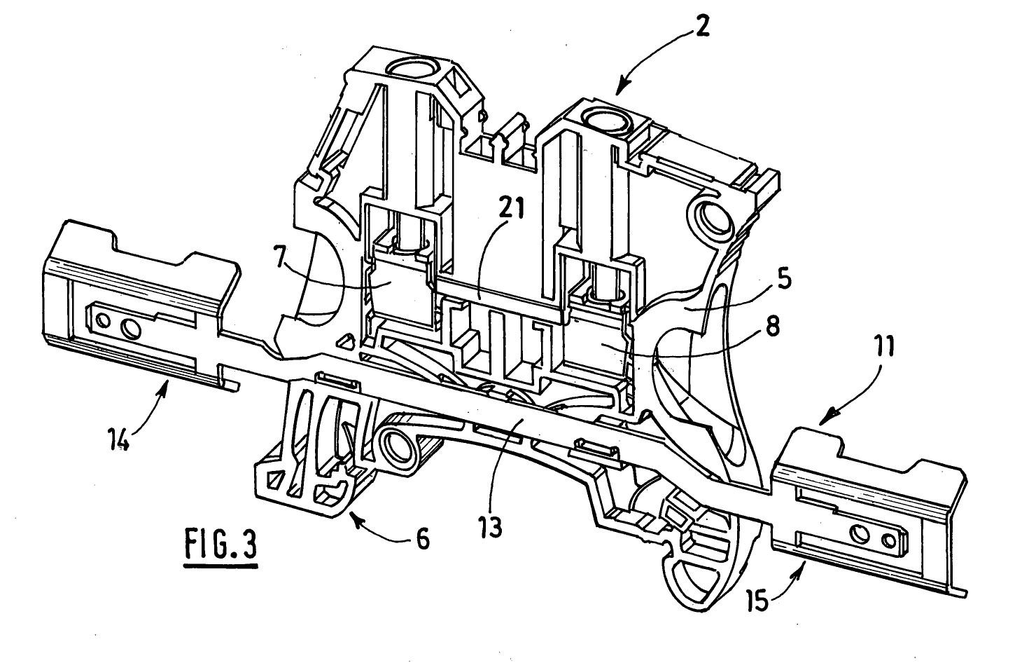

According to an embodiment shown in FIGS. 1 to 6, a connection apparatus 2 of conductors 3, 4 comprises an insulating body 5 designed to be attached to a rail by a mounting foot 6 situated on a rear face.

The connection apparatus 2 also comprises two connection terminals 7, 8 for conductors, positioned on either side of the insulating body, and electrically connected via a conductive connection bar 21.

The connection terminals 7, 8 may be, without distinction, terminals for connection by screwing or by elastic clamping with a spring.

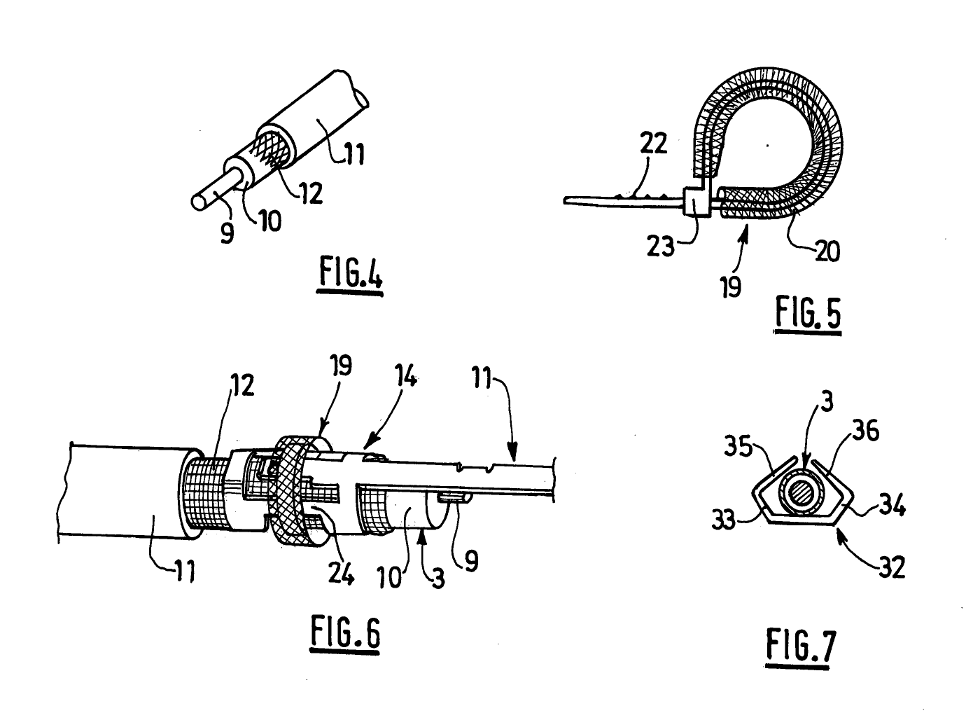

As shown in FIG. 4, the shielded conductors 3, 4 designed to be connected via the apparatus 2 each comprise a metal conductive core 9, and an insulating sheath 10 surrounding the conductive core, for example made of plastic. Each conductor also comprises a shielding sheath 12, made for example by a metal braid, which surrounds the insulating sheath 10, and a second external insulating sheath 11, which surrounds the shielding sheath 12.

The apparatus 2 also comprises a conducting device 11 designed to ensure at least partial continuity of the shielding, comprising a conducting element in the form of a conductive bar 13 extending between a first end close to a first connection terminal 7 and a second end close to a second connection terminal 8.

At each of the ends of the bar 13, the device 11 comprises a housing member 14, 15 comprising a bottom 16 in the axis of the bar 13 and two branches 17 and 18, which, leaving the bottom 16, move away from one another in an oblique manner in order to form a housing designed to receive a portion of a shielded conductor 3, 4 surrounded by its shielding sheath 12, the external insulating sheath 11 of the conductor 3, 4 being removed on the terminal portion of the latter before it is placed in the housing member 14, 15.

The device 11 comprises means for holding the housing member 14, 15 in position in contact with the shielding sheath 12 of the conductor.

The means for holding in position consist, in this embodiment, in a fitted clamping collar 19 comprising a conductive sheath 20. In particular, in the embodiment shown, the collar consists of a colson collar surrounded by a sheath made of a metal braid, as shown in FIG. 5.

The collar 19 therefore consists of a tab made of flexible material, in particular of plastic, comprising a multiplicity of grooves or ribs 22, the tab comprising a free end and a second end comprising an eyelet 23 in which a snap-fitting anti-return device is placed. Therefore, when the free end of the tab is inserted into the eyelet, the anti-return device interacts with the grooves or ribs in order to allow the loop formed by the tab to be tightened only, but not loosened.

The branches 17, 18 of the housing member 14, 15 comprise a profile having a positioning notch 24 for the clamping collar 19, in which the latter is housed when it is placed in position around the housing member 14, 15 and the shielded conductor with its sheath.

FIG. 6 represents a shielded conductor in position on a housing member 14, with an attachment collar 19.

Each housing member 14, 15 has a recess 25 at its bottom. Starting from the edge of this recess, and housed in the latter, a connection lug 26, situated in the axis of the bar, is arranged.

This connection lug 26 comprises two through-openings 27, 28 allowing the passage of a strand formed by the twisted end of a shielding sheath. Once the strand is positioned in the opening, the strand can be soldered.

The second opening 28, of smaller size, is also of appropriate size to receive a protruding portion for attaching a fitted external cable terminal to the end of a twisted strand formed on a shielding sheath.

To more easily achieve the attachment with the connection lug 26, it is possible to bend the latter in order to move it out of the plane of the bar 13, and therefore from the recess of the housing member 14, 15.

The bar 13 comprises means for attachment to the insulating body 5 of the apparatus, these means consisting of lugs 29 designed to be accommodated in openings of the insulating body.

It should be noted that the bar 13 and the housing members 14, 15 are made in a single piece to simplify manufacture.

It should be noted that the connection apparatus is a connection apparatus of the conventional type, the body of which comprises simply openings for accommodating the device.

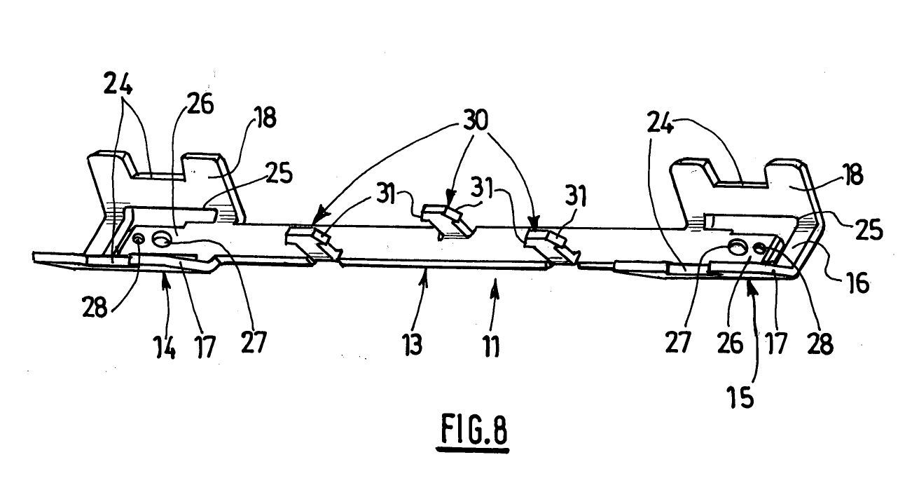

According to a variant shown in FIG. 8, the bar 13 comprises means for attachment to the insulating body 5 of the apparatus, these means consisting of snap-fitting elements 30 designed to be accommodated in openings of the insulating body. These snap-fitting elements each consist of a lug comprising snap-fitting protrusions 31 laterally on its two sides.

According to a variant, the device may connect a shielded conductor to a shielding reference element consisting, for example, of the earth of the apparatus, or of a specific electromagnetic protection device. In this case, only one housing member associated with means for holding in position is necessary.

According to a second embodiment, shown in FIG. 7, the means for holding in position no longer consist of a clamping collar. In this embodiment, the housing member 32 comprises branches 33, 34 with convergent end portions 35, 36 designed to be crimped around the conductor.

As it goes without saying, the invention is not limited to the preferred embodiments described above as nonlimiting examples; on the contrary, it covers all the variants.

In particular, other means for holding the housing member in position on the conductor may be used, in the form of a fitted element or of part of the housing member.

1. A conductive device for electrical contact between a first shielding sheath of a first shielded conductor, and a second shielding sheath of a second shielded conductor or a reference element for shielding, the device being designed to be fitted to an electrical connection apparatus comprising at least one conductor connection terminal, said device comprising:
a conducting element extending between a first end designed to be placed close to a first connection terminal of the apparatus and a second end designed to be placed close to a second connection terminal of the apparatus, or in contact with the reference element for shielding,
at least one housing member of a conductor surrounded by its sheath, this member being in electrical contact with one of the ends of the conducting element, and
means for holding the housing member in position in contact with the shielding sheath of a conductor; and
a connection lug comprising at least one opening particularly allowing passage of a strand formed by an end of a twisted shielding sheath of a shielded conductor or the housing of a protruding portion for the attachment of a fitted external cable terminal.

2. The device as claimed in claim 1, wherein the housing member has a concave shape for housing the conductor.

3. The device as claimed in claim 2, wherein the housing member comprises a bottom and two lateral branches extending obliquely relative to the bottom.

4. The device as claimed in claim 1, wherein the connection lug is made in a recess of the housing member.

5. The device as claimed in claim 1, wherein the connection lug is pliable relative to the housing member.

6. The device as claimed in claim 1, wherein the means for holding the housing member in position on the conductor comprise at least one portion of the housing member that is designed to be crimped around the conductor.

7. The device as claimed in claim 6, wherein the at least one portion designed to be crimped around the conductor comprises at least one end portion of a branch of the housing member.

8. The device as claimed in claim 1, wherein the means for holding the housing member in position on the conductor comprise a fitted clamping collar.

9. The device as claimed in claim 8, wherein the clamping collar comprises a conductive sheath.

10. The device as claimed in claim 8, wherein the guidance housing member comprises at least one positioning notch for the clamping collar.

11. The device as claimed in claim 10, wherein the branches of the guidance housing member comprise a profile having a positioning notch for the clamping collar.

12. The device as claimed in claim 1, wherein it comprises means for attachment to the insulating body of the apparatus.

13. The device as claimed in claim 12, wherein the means for attachment to the insulating body of the apparatus comprise snap-fitting elements.

14. The device as claimed in claim 1, wherein the conducting element, comprising a bar, and the at least one housing member are made in a single piece.

15. A low-voltage connection apparatus comprising a device as claimed in claim 1.
